(19) United States
(12) Patent Application Publication
(10) Pub. No.: US 2018/0067978 A1
(43) Pub. Date: Mar. 8, 2018

(54) LOG MANAGEMENT METHOD, LOG MANAGEMENT DEVICE, AND RECORDING MEDIUM

(71) Applicant: Fujitsu Limited, Kawasaki-shi (JP)

(72) Inventor: Kazuki MATSUURA, Saitama (JP)

(73) Assignee: Fujitsu Limited, Kawasaki-shi (JP)

(21) Appl. No.: 15/678,306

(22) Filed: Aug. 16, 2017

(30) Foreign Application Priority Data
Sep. 7, 2016 (JP) 2016-175074

(51) Int. Cl. G06F 17/30; H04L 12/26; H04L 29/08; G06F 11/14; G06F 11/34; G06F 11/22

(52) U.S. Cl. CPC G06F 17/30345; H04L 43/065; H04L 67/16; G06F 11/2038; G06F 11/3476; G06F 11/14; G06F 11/2205; G06F 11/1471

(57) ABSTRACT

A log management method executed by a processor included in a log management device that manages logs of a plurality of devices, the log management method includes receiving a plurality of logs from one of the plurality of devices; generating a plurality of time stamps and a plurality of bodies by separation of the plurality of time stamps from the plurality of logs; sorting the plurality of time stamps and the plurality of bodies based on information included in the plurality of bodies; compressing the sorted plurality of bodies and the plurality of sorted time stamps; restoring, when a request to refer to the plurality of logs is received, the plurality of logs by decompressing the compressed plurality of bodies and the plurality of compressed time stamps; and outputting the restored plurality of logs.

### CROSS-REFERENCE TO RELATED APPLICATION

This application is based upon and claims the benefit of priority of the prior Japanese Patent Application No. 2016-175074, filed on Sep. 7, 2016, the entire contents of which are incorporated herein by reference.

### FIELD

The embodiments discussed herein are related to a log management method, a log management device, and a recording medium.

### BACKGROUND

When a plurality of devices is used in a data center or the like, log files of the respective devices are aggregated and managed. Due to the aggregation of the log files, it becomes unnecessary to access each of the devices when the corresponding log file is referred to. Because access to a device in which a failure occurs may not be performed, pieces of log information may be collected reliably due to the aggregation of the log files in an aggregation device in advance.

However, when the log files are aggregated in one location, the desired capacity for a hard disk device that stores the log files increases in proportion to the number of devices. Therefore, the aggregation device compresses the log files and stores the compressed log files in the hard disk device.

In a case in which collected pieces of data are divided and compressed, and transfer of the compressed pieces of data is performed, there is a technology by which a transfer time is reduced when a division unit divides the collected pieces of data in accordance with a storage capacity usable for data transfer and data compression in a storage capacity of a storage unit that stores the collected pieces of data. As the related art, for example, Japanese Laid-open Patent Publication No. 2002-163180 and the like are disclosed.

In compression of a log file in the related art, compression corresponding to the feature of the log file is not performed, so that there is a problem in which a compression ratio is not good. For example, a log file may have a feature in which only time stamps are different between two logs. When the compression is performed based on such a feature of the log file, the compression ratio may be improved.

### SUMMARY

According to an aspect of the invention, a log management method executed by a processor included in a log management device that manages logs of a plurality of devices, the log management method includes receiving a plurality of logs from one of the plurality of devices; generating a plurality of time stamps and a plurality of bodies by separation of the plurality of time stamps from the plurality of logs; sorting the plurality of time stamps and the plurality of bodies based on information included in the plurality of bodies; compressing the sorted plurality of bodies and the plurality of sorted time stamps; restoring, when a request to refer to the plurality of logs is received, the plurality of logs by decompressing the compressed plurality of bodies and the plurality of compressed time stamps; and outputting the restored plurality of logs.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating compression using a dictionary;

FIG. 2 is a diagram illustrating an example of a log file;

FIG. 3 is a diagram illustrating an example of a location information table;

FIG. 4 is a diagram illustrating a log main part, a time stamp, and order information at the time of one-line processing;

FIG. 5 is a diagram illustrating log main parts, time stamps, and pieces of order information at the time of completion of entire-lines processing;

FIG. 6 is a diagram illustrating the log main parts, the time stamps, and the pieces of order information after sorting;

FIG. 7 is a diagram illustrating a combination result of the lines of the log main parts, the lines of the time stamps, and the lines of the pieces of order information;

FIG. 8 is a diagram illustrating the log main parts, the time stamps, and the pieces of order information after association;

FIG. 9 is a diagram illustrating the log main parts, the time stamps, and the pieces of order information after sorting;

FIG. 10 is a diagram illustrating a log file text at the time of one-line processing;

FIG. 11 is a diagram illustrating the log file text at the time of completion of entire-lines processing;

FIG. 12 is a diagram illustrating a function configuration of an aggregation device according to a first embodiment;

FIG. 13 is a flowchart illustrating a flow of processing by a preprocessing unit;

FIG. 14 is a flowchart illustrating a flow of processing by a restoration unit;

FIG. 15 is a diagram illustrating combination of log files by an aggregation device according to a second embodiment;

FIG. 16 is a diagram illustrating an example of two log files;

FIG. 17 is a diagram illustrating a procedure in which addition information associated with a log file is added to the beginning of a time stamp;

FIGS. 18A and 18B are diagrams each illustrating a log file after pieces of addition information associated with the log file are added to the beginnings of the time stamps;

FIG. 19 is a diagram illustrating a log file after combination;

FIG. 20 is a diagram illustrating an example of a correspondence table between addition information and an original log file name;

FIG. 21 is a flowchart illustrating a flow of multiple file combination processing; and

FIG. 22 is a diagram illustrating a hardware configuration of a computer that executes an aggregation program according to an embodiment.

### DESCRIPTION OF EMBODIMENTS

Embodiments of a log management device and a log management program of the technology disclosed herein are described below in detail with reference to drawings. In a first embodiment, as the log management device, an aggregation device that compresses and stores log files of respective servers is described, and in a second embodiment, as the log management device, an aggregation device that collects logs of a plurality of servers into a single log file, and compresses and stores the collected logs is described. The technology disclosed herein is not limited to the first and second embodiments.

### First Embodiment

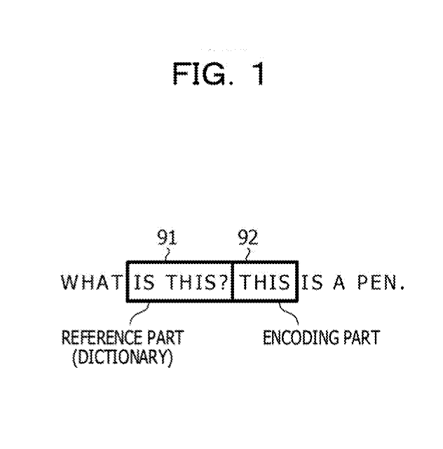

As compression of log files, compression using a dictionary is utilized. As the compression using a dictionary, for example, there is a LZSS code and a LZ77 code. FIG. 1 is a diagram illustrating the compression using a dictionary. In FIG. 1, “WHAT IS THIS? THIS IS A PEN.” is a text to be compressed. A reference part 91 is a part of the text that is a compression target, and is used as a dictionary.

An encoding part 92 is a part to be compressed. It is determined whether the same character string as the text of the encoding part 92 exists in the reference part 91. When the same character string exists in the reference part 91, the character string of the encoding part 92 is converted into the position and the length of the character string in the dictionary. In FIG. 1, “THIS” of the encoding part 92 exists in the dictionary, and is replaced with (3, 4) that is a pair of (position, length).

When both of the lengths of the reference part 91 and the encoding part 92 are 256 characters, 8 bits are desired in order to express the position and the length for each of the units, so that 16 bits are desired in total. On the other hand, in order to express four characters before compression, 32 bits are desired in an ASCII code, so that the bit length after conversion becomes halved.

The reference part 91 has a fixed length, so that the reference part 91 moves due to movement of the encoding part 92. When the reference part 91 becomes large, a probability increases in which the character string of the encoding part 92 exists in the reference part 91. However, the number of bits desired to express the position of the data after conversion also increases, so that the compression ratio may not be improved. The reference part 91 moves due to movement of the encoding part 92, so that the compression ratio is improved when the same character strings exist nearby. Therefore, in the compression according to the first embodiment, the compression ratio is improved when preprocessing is executed for the log file so that the same character strings exist nearby.

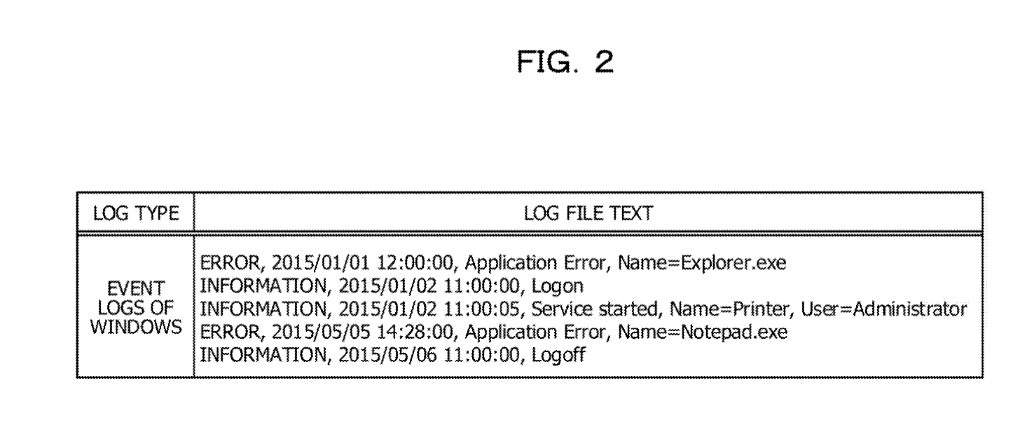

FIGS. 2 to 7 are diagrams each illustrating an example of preprocessing according to the first embodiment. FIG. 2 is a diagram illustrating an example of a log file to be preprocessed. As illustrated in FIG. 2, the type of logs corresponds to event logs of Windows (registered trademark). A log file text corresponds to logs collected as event logs.

Each of the logs includes a time stamp at a certain position. In FIG. 2, for example, “2015/01/01 12:00:00” in a log of the first line is a time stamp. The position of the time stamp in the log is defined depending on each log type in a location information table.

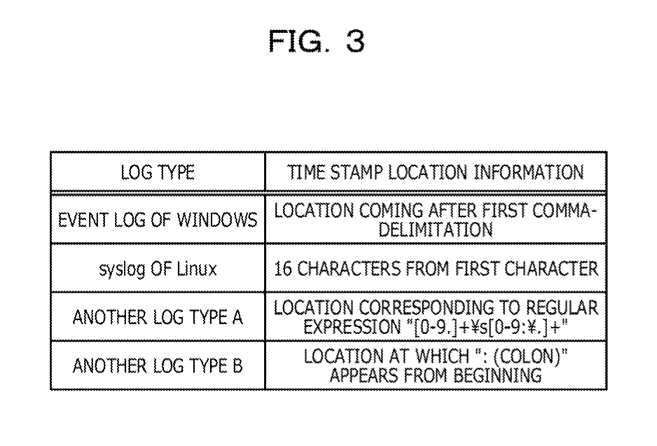

FIG. 3 is a diagram illustrating an example of the location information table. As illustrated in FIG. 3, in the location information table, a log type and time stamp location information are associated with each other. For example, in the event logs of Windows, the position of a time stamp comes after the first comma-delimitation.

The preprocessing unit according to the first embodiment extracts information on a time stamp from each of the lines with reference to the location information table. In addition, the preprocessing unit according to the first embodiment adds order information n to each of the lines. Here, “n” is a number indicating order of the corresponding line in the log file. In addition, “n” is expressed by a fixed bit length. The bit length is the minimum number of bits allowed to express the total number of lines of the log file. For example, when the total number of lines of the log file is 1000, “2⁹=512<1000<1024=2¹⁰” is satisfied, so that the bit length of “n” is 10.

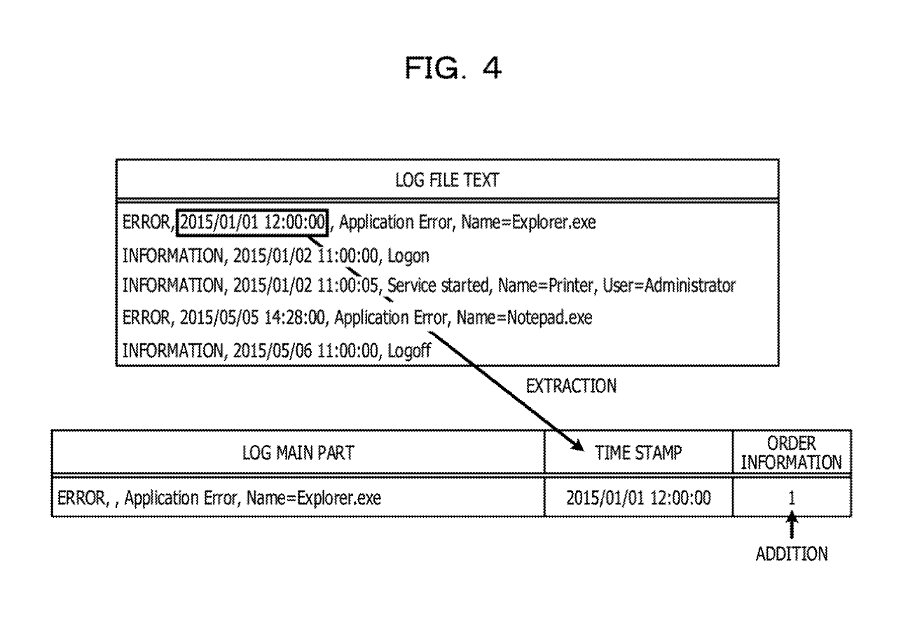

FIG. 4 is a diagram illustrating a log main part, a time stamp, and order information at the time of one-line processing. Here, the log main part is a part that is the remaining character string after the time stamp is extracted from the log. As illustrated in FIG. 4, a time stamp “2015/01/01 12:00:00” is extracted from “Error, 2015/01/01 12:00:00, Application Error, Name=Explorer.exe”, and order information “1” is added to the log. The log main part is “Error, Application Error, Name=Explorer.exe” obtained after the time stamp is removed from the log.

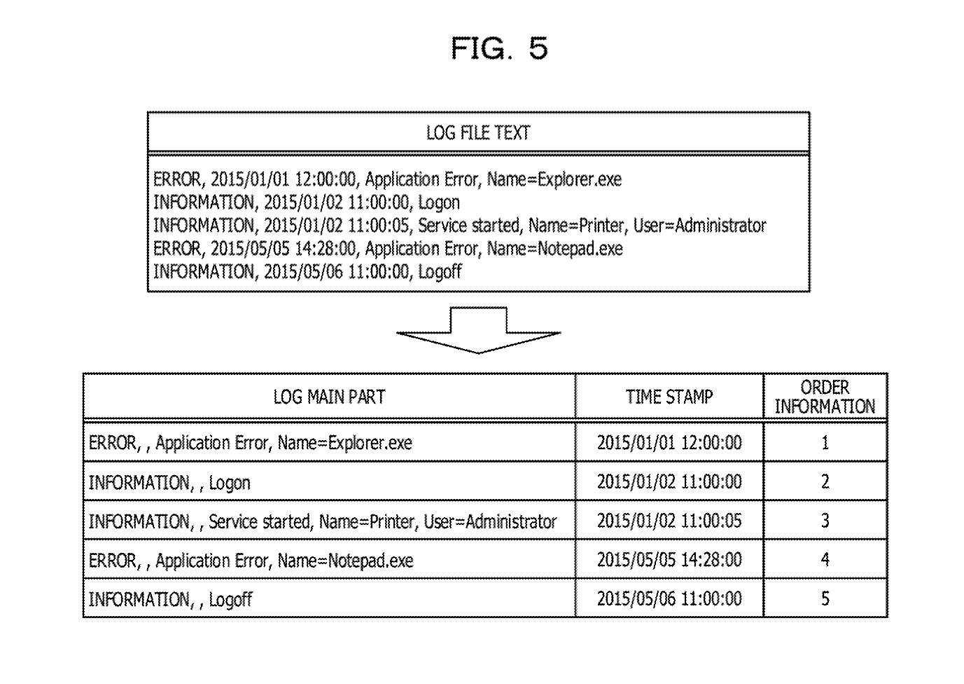

FIG. 5 is a diagram illustrating log main parts, time stamps, and pieces of order information at the time of completion of entire-lines processing. As illustrated in FIG. 5, time stamps “2015/01/01 12:00:00” to “2015/05/06 11:00:00” are extracted from the logs, and pieces of order information “1” to “5” are added to the logs, respectively.

In addition, the preprocessing unit according to the first embodiment compares the sizes of character strings of the log main parts from the beginning of the character strings, and sorts the log main parts in ascending order. At that time, the preprocessing unit according to the first embodiment also rearranges the time stamps and the pieces of order information in accordance with the sorting of the log main parts.

As a method in which the sizes of character strings are compared, for example, there is a method in which character codes are used. In such a method, for example, a character code of a symbol “a” in ASCII is “0x61” and a character code of a symbol “b” is “0x62”, so that sorting is performed using a condition of “a<b”.

First, the preprocessing unit according to the first embodiment compares the first characters, performs size comparison using the character codes on the first characters, and uses the magnitude relation when the sizes are determined at this point. When the sizes are the same, similarly, the preprocessing unit according to the first embodiment compares the sizes of the next characters using the character codes. In addition, the preprocessing unit according to the first embodiment performs such comparison up to the last characters of the character strings, and determines that the two character strings are the same when the sizes are the same up to the last characters.

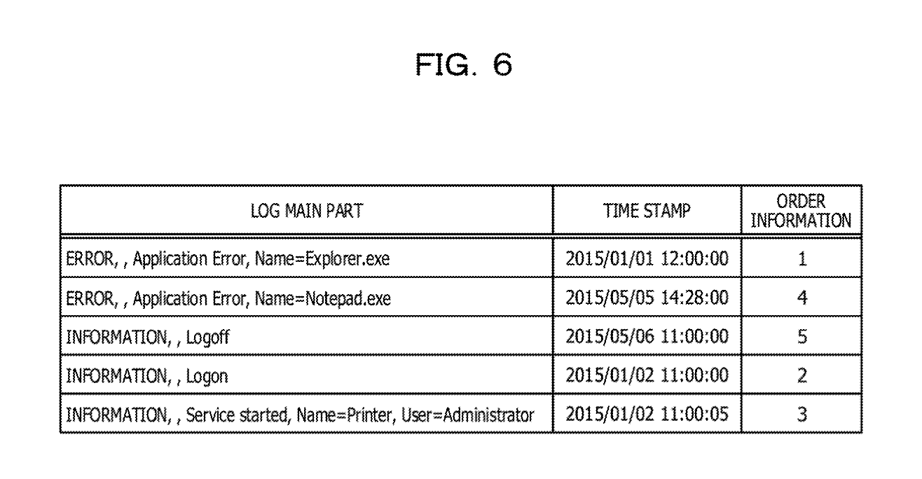

FIG. 6 is a diagram illustrating the log main parts, the time stamps, and the pieces of order information after the sorting. As illustrated in FIG. 6, as a result of the sorting, lines in each of which a character string “Error” is included as the first character string of the line are the initial two lines, and lines in each of which a character string “Information” is included the first character string of the line are the remaining three lines. That is, the lines are rearranged so that lines including similar log main parts exist nearby.

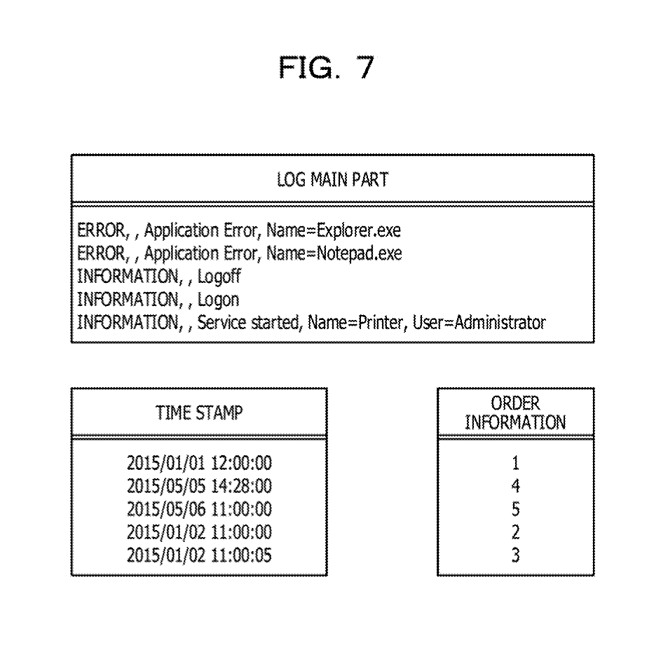

In addition, the preprocessing unit according to the first embodiment combines the lines of the log main parts, combines the lines of the time stamps, and combines the lines of the pieces of order information to create three files for the respective combined lines. FIG. 7 is a diagram illustrating a combination result of the lines of the log main parts, the lines of the time stamps, and the lines of the pieces of order information. As illustrated in FIG. 7, a file obtained by combining the lines of the log main parts, a file obtained by combining the lines of the time stamps, and a file obtained by combining the lines of the pieces of order information are created.

The created three files are compressed by a compression unit and stored in a hard disk device of the aggregation device. As compared with a case in which preprocessing is not performed, the file size is reduced even when the three files are combined.

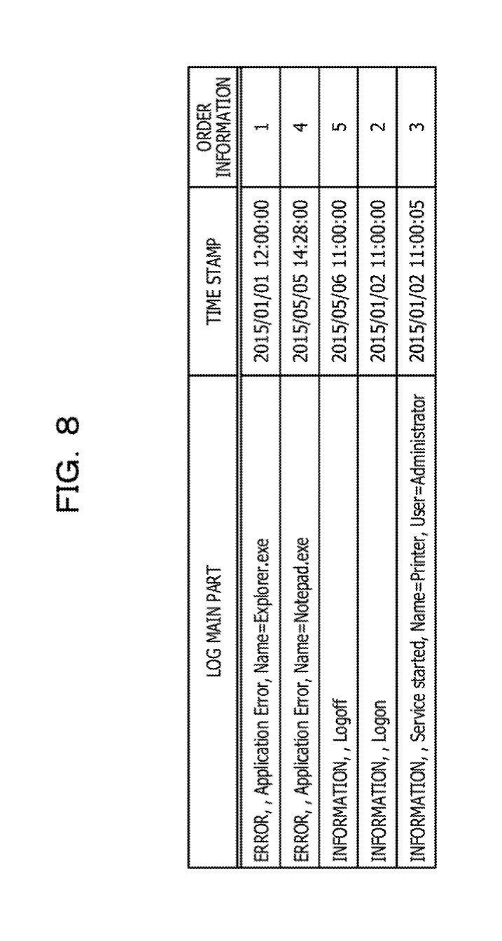

FIGS. 8 to 11 are diagrams each illustrating restoration processing to a log file before the preprocessing. The restoration unit according to the first embodiment reads the three files decompressed by a decompression unit for each of the lines and associates the read files with each other. FIG. 8 is a diagram illustrating log main parts, time stamps, and pieces of order information after the association. As illustrated in FIG. 8, for example, a log main part “Error, Application Error, Name=Explorer.exe”, a time stamp “2015/01/01 12:00:00”, and order information “1” are associated with each other.

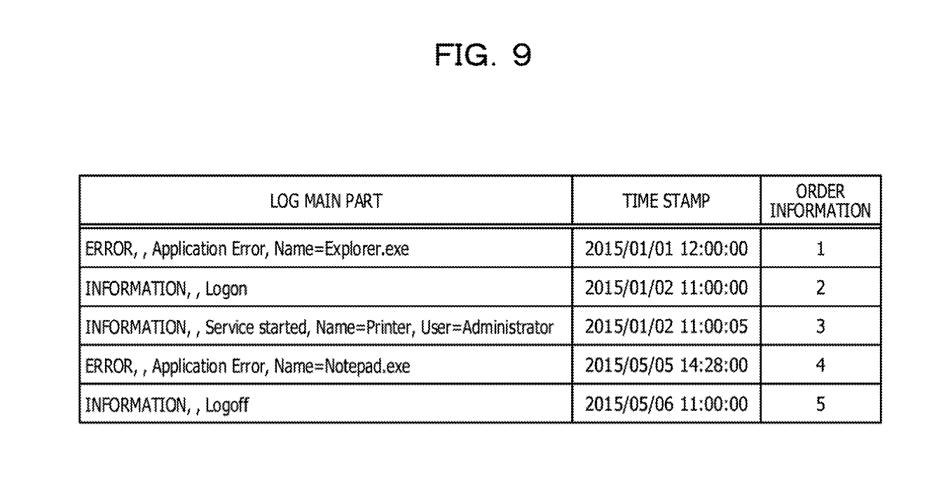

In addition, the restoration unit according to the first embodiment sorts the pieces of order information in ascending order. At that time, the restoration unit according to the first embodiment rearranges the log main parts and the time stamps in accordance with the sorting of the pieces of order information. FIG. 9 is a diagram illustrating the log main parts, the time stamps, and the pieces of order information after the sorting. As illustrated in FIG. 9, the log main parts, the time stamps, and the pieces of order information are sorted in ascending order of the pieces of order information.

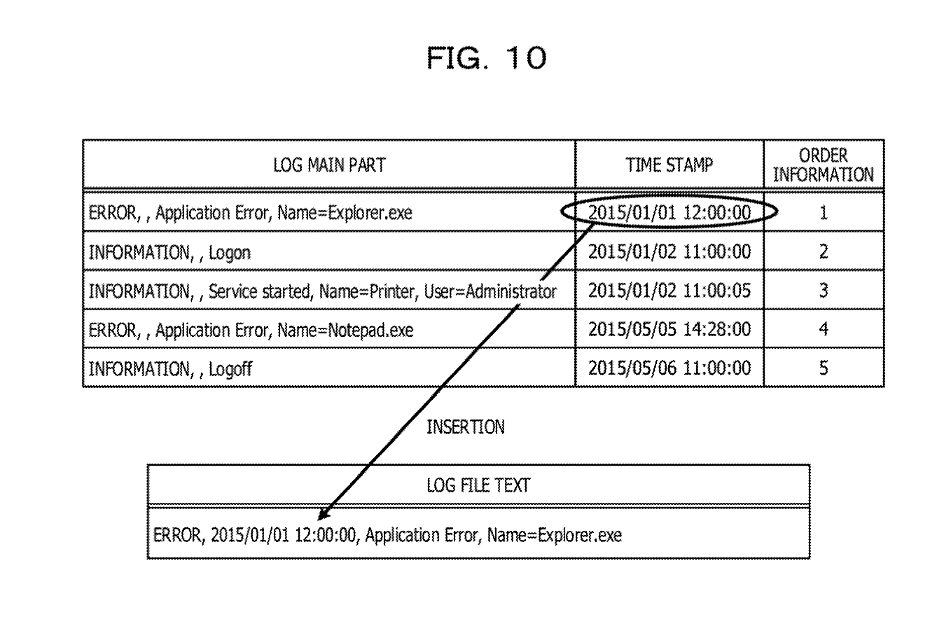

In addition, the restoration unit according to the first embodiment restores the log file text by inserting information on the time stamp into the log main part for each of the lines in the location information table and deleting the order information from the line. FIG. 10 is a diagram illustrating the log file text at the time of one-line processing. As illustrated in FIG. 10, for example, the log file text is restored from the log main part “Error, Application Error, Name=Explorer.exe” and the time stamp “2015/01/01 12:00:00”. The restored log file text is “Error, 2015/01/01 12:00:00, Application Error, Name=Explorer.exe”.

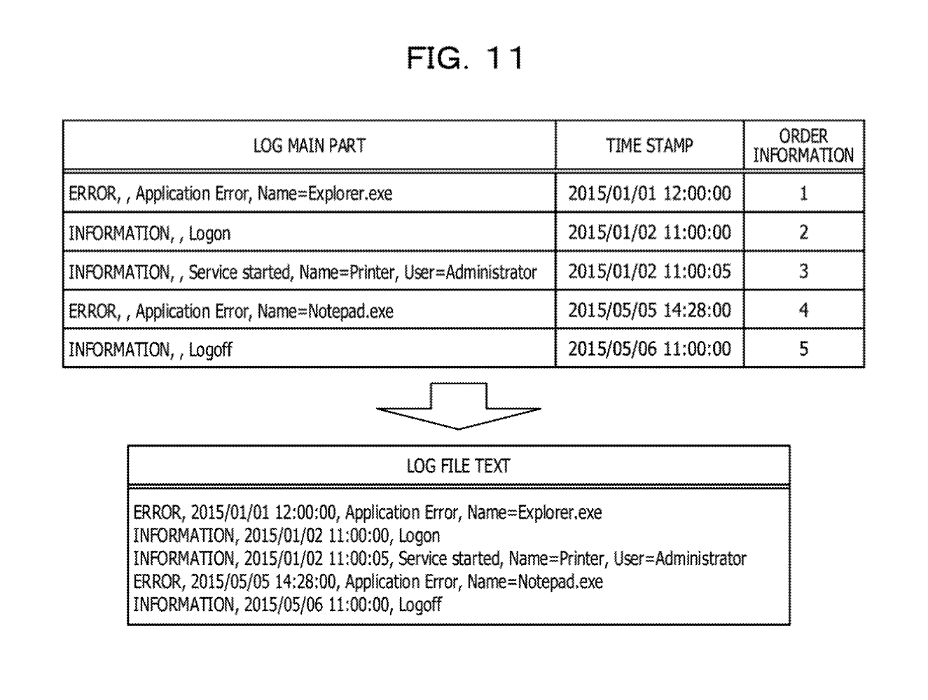

FIG. 11 is a diagram illustrating the log file text at the time of completion of entire-lines processing. As illustrated in FIG. 11, time stamps “2015/01/01 12:00:00” to “2015/05/06 11:00:00” are inserted into the lines of log main parts corresponding thereto, and the log file text having the five lines is restored.

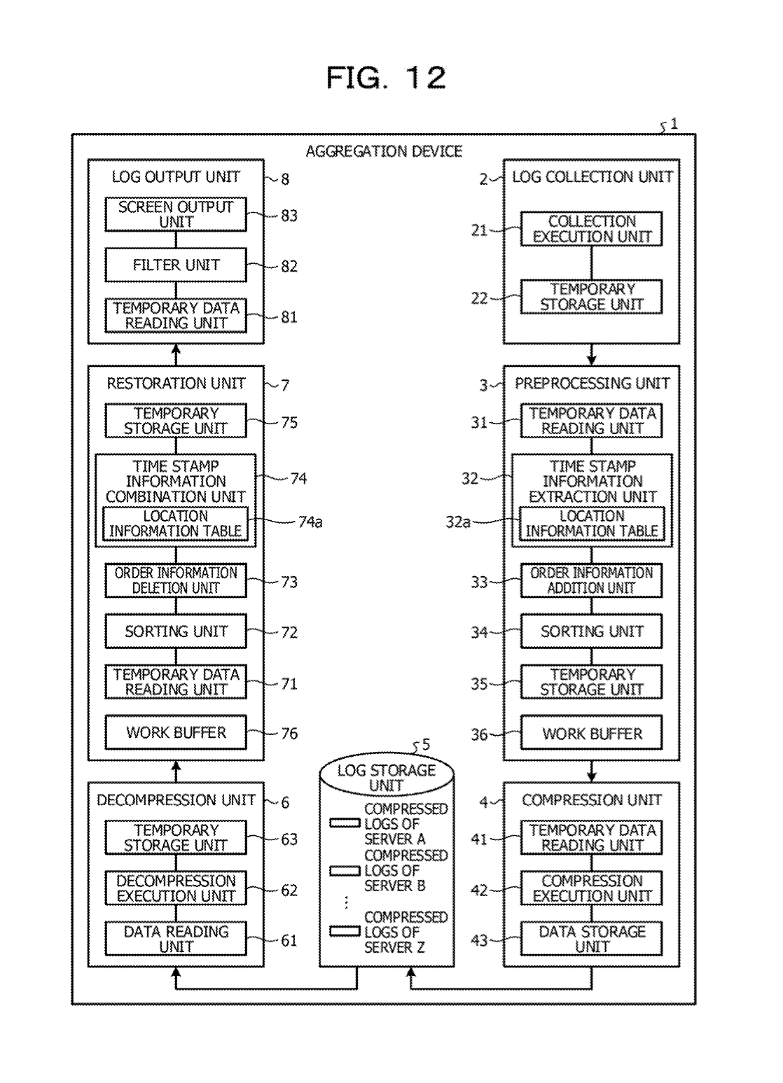

A function configuration of the aggregation device according to the first embodiment is described below. FIG. 12 is a diagram illustrating the function configuration of the aggregation device according to the first embodiment. As illustrated in FIG. 12, an aggregation device 1 according to the first embodiment includes a log collection unit 2, a preprocessing unit 3, a compression unit 4, a log storage unit 5, a decompression unit 6, a restoration unit 7, and a log output unit 8.

The log collection unit 2 collects log files from a plurality of servers and stores the log file for each of the servers in the hard disk device. The log collection unit 2 includes a collection execution unit 21 and a temporary storage unit 22. The collection execution unit 21 collects the log file from each of the servers. The temporary storage unit 22 stores the log file collected by the collection execution unit 21 in the hard disk device for each of the servers.

The preprocessing unit 3 reads the log file from the hard disk device, executes preprocessing for the log file, and stores the preprocessing result in the hard disk device. The preprocessing unit 3 includes a temporary data reading unit 31, a time stamp information extraction unit 32, an order information addition unit 33, a sorting unit 34, a temporary storage unit 35, and a work buffer 36.

The temporary data reading unit 31 reads the log file from the hard disk device. The time stamp information extraction unit 32 extracts information on a time stamp from each log of the log file based on a location information table 32a. The order information addition unit 33 adds order information to each of the logs.

The sorting unit 34 sorts log main parts, time stamps, and pieces of order information, based on the log main parts. The temporary storage unit 35 stores the log main parts, the time stamps, and the pieces of order information that have been sorted by the sorting unit 34, in different files, in the hard disk device. The work buffer 36 is a work storage area used by the preprocessing unit 3.

The compression unit 4 reads the files of the log main parts, the time stamps, and the pieces of order information and compresses the files, and stores the files in the log storage unit 5. The compression unit 4 includes a temporary data reading unit 41, a compression execution unit 42, and a data storage unit 43.

The temporary data reading unit 41 reads the files of the log main parts, the time stamps, and the pieces of order information from the hard disk device. The compression execution unit 42 compresses the files of the log main parts, the time stamps, and the pieces of order information, which have been read by the temporary data reading unit 41, using a dictionary. The data storage unit 43 stores the files of the log main parts, the time stamps, and the pieces of order information, which have been compressed by the compression execution unit 42, in the log storage unit 5.

The log storage unit 5 stores the compressed logs for each of the servers. That is, the log storage unit 5 stores the files of the log main parts, the time stamps, and the pieces of order information, which have been compressed by the compression unit 4, for each of the servers. The log storage unit 5 is an area in the hard disk device.

The decompression unit 6 reads the compressed logs from the log storage unit 5, decompresses the compressed logs, and stores the logs in the hard disk device. The decompression unit 6 includes a data reading unit 61, a decompression execution unit 62, and a temporary storage unit 63. The data reading unit 61 reads the files of the log main parts, the time stamps, and the pieces of order information from the log storage unit 5. The decompression execution unit 62 decompresses the files of the log main parts, the time stamps, and the pieces of order information, which have been read by the data reading unit 61. The temporary storage unit 63 stores the files of the log main parts, the time stamps, and the pieces of order information, which have been decompressed by the decompression execution unit 62, in the hard disk device.

The restoration unit 7 restores the log file from the files of the log main parts, the time stamps, and the pieces of order information, which have been decompressed by the decompression unit 6. The restoration unit 7 includes a temporary data reading unit 71, a sorting unit 72, an order information deletion unit 73, a time stamp information combination unit 74, a temporary storage unit 75, and a work buffer 76.

The temporary data reading unit 71 reads the files of the log main parts, the time stamps, and the pieces of order information, which have been decompressed by the decompression unit 6, from the hard disk device, and associates the three files with each other for each of the lines. The sorting unit 72 sorts the log main parts, the time stamps, and the pieces of order information based on the pieces of order information.

The order information deletion unit 73 deletes the pieces of order information after the sorting by the sorting unit 72 from the lines. The time stamp information combination unit 74 restores the log file text by inserting pieces of information on the time stamps into the log main parts using a location information table 74a. The temporary storage unit 75 stores the log file text restored by the time stamp information combination unit 74, in the hard disk device, as a log file. The work buffer 76 is a work storage area used by the restoration unit 7.

The log output unit 8 displays information on a log that satisfies a condition specified by the user, on a display device. The log output unit 8 includes a temporary data reading unit 81, a filter unit 82, and a screen output unit 83. The temporary data reading unit 81 reads the log file restored by the restoration unit 7, from the hard disk device. The filter unit 82 extracts the log that satisfies the condition specified by the user, from the log file. The screen output unit 83 displays information on the log extracted by the filter unit 82, on the display device.

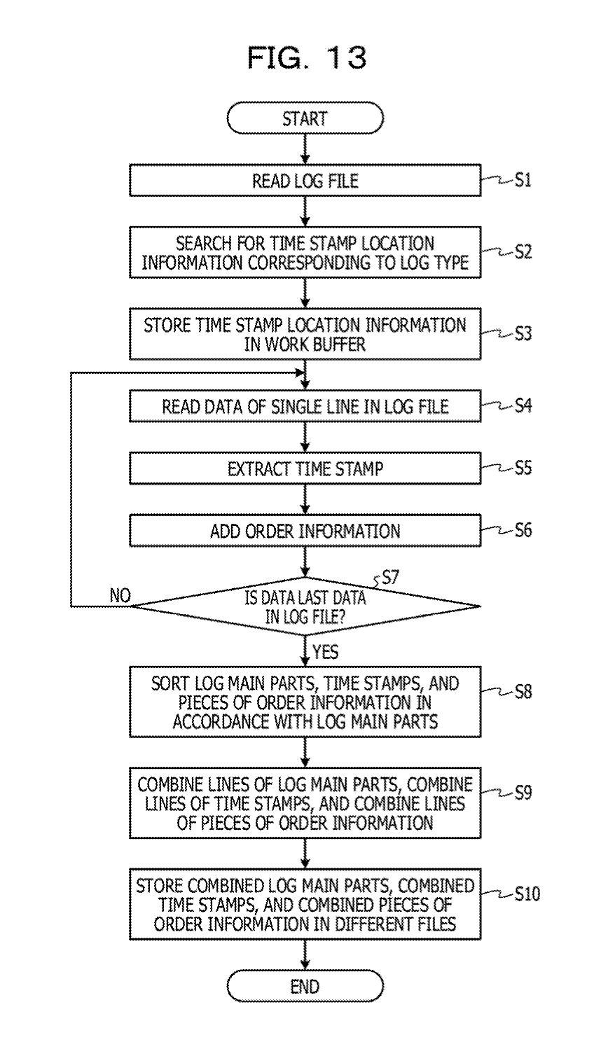

A flow of the processing by the preprocessing unit 3 is described below. FIG. 13 is a flowchart illustrating the flow of the processing by the preprocessing unit 3. As illustrated in FIG. 13, the preprocessing unit 3 reads a log file (S1). In addition, the preprocessing unit 3 searches the location information table 32a for time stamp location information corresponding to the log type (S2). In addition, the preprocessing unit 3 stores the time stamp location information in the work buffer 36 (S3).

After that, the preprocessing unit 3 reads data of a single line in the log file (S4). In addition, the preprocessing unit 3 extracts a time stamp based on the time stamp location information (S5). In addition, the preprocessing unit 3 adds order information to the line (S6) and determines whether the data is the last data in the log file (S7). When the data is not the last data in the log file, in the preprocessing unit 3, the flow returns to S4.

On the other hand, when the data is the last data in the log file, the preprocessing unit 3 sorts log main parts, time stamps, and pieces of order information in accordance with the log main parts (S8) and combines the lines of the log main parts, combines the lines of the time stamps, and combines the lines of the pieces of order information (S9). In addition, the preprocessing unit 3 stores the combined log main parts, the combined time stamps, and the combined pieces of order information in different files (S10).

As described above, the preprocessing unit 3 may rearrange the logs so that logs having the same character string exist nearby by sorting the log main parts, the time stamps, and the pieces of order information in accordance with the log main parts.

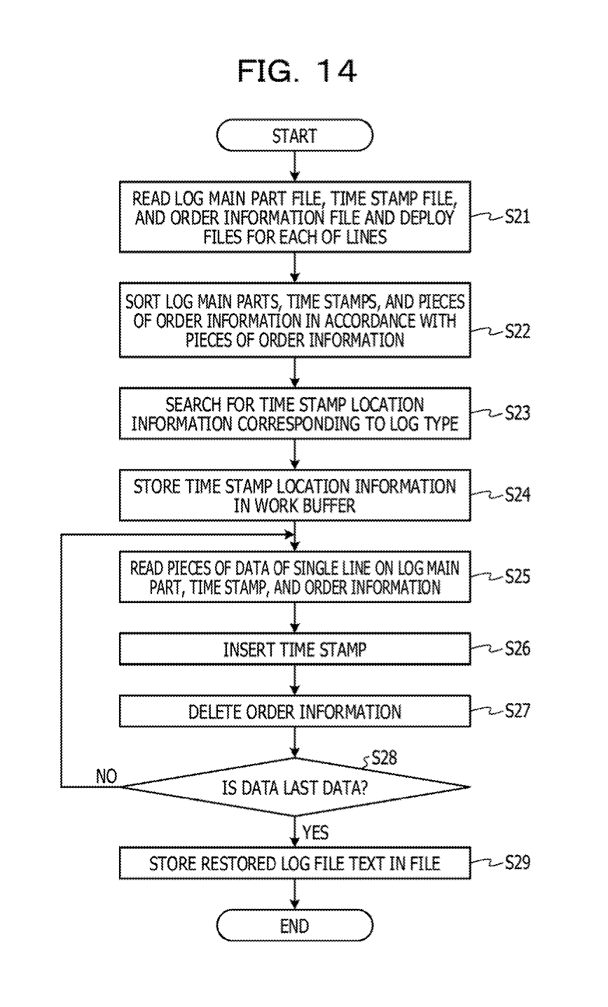

A flow of the processing by the restoration unit 7 is described below. FIG. 14 is a flowchart illustrating the flow of the processing by the restoration unit 7. As illustrated in FIG. 14, the restoration unit 7 reads a log main part file, a time stamp file, an order information file and deploys the files for each of the lines (S21). Here, the deployment for each of the line is performed so that the files are associated with each other for the line.

After that, the restoration unit 7 sorts the log main parts, the time stamps, and the pieces of order information in accordance with the pieces of order information (S22). In addition, the restoration unit 7 searches the location information table 74a for time stamp location information corresponding to the log type (S23). In addition, the restoration unit 7 stores the time stamp location information in the work buffer 76 (S24).

After that, the restoration unit 7 reads pieces of data of a single line on a log main part, a time stamp, and order information (S25) and inserts the time stamp into the log main part, based on the time stamp location information (S26). In addition, the restoration unit 7 deletes the order information from the log (S27) and determines whether the data is the last data in the log file (S28).

After that, when the data is not the last data in the log file, in the restoration unit 7, the flow returns to S25. When the data is the last data in the log file, the restoration unit 7 stores the restored log file text in the file (S29).

As described above, the restoration unit 7 may restore the log file by rearranging the logs in the original order, returning the time stamps to the original positions of the logs, and deleting the pieces of order information from the logs.

As described above, in the first embodiment, the time stamp information extraction unit 32 extracts time stamps from a log file text, and the sorting unit 34 sorts log main parts and the time stamps, based on the log main parts. In addition, the compression execution unit 42 compresses the log main parts and the time stamps that have been sorted by the sorting unit 34. Thus, the aggregation device 1 may arrange the logs so that logs including the same character string exist nearby, and improve the compression ratio of the log file.

In the first embodiment, the order information addition unit 33 adds pieces of order information to the logs, and the sorting unit 34 sorts the log main parts, the time stamps, and the pieces of order information, based on the log main parts. Thus, the aggregation device 1 may restore the logs using the pieces of order information.

### Second Embodiment

In the above-described first embodiment, the case is described in which a log file is compressed for each server. In addition, log files of the respective servers may be collected into a single log file and may be compressed. Therefore, in a second embodiment, an aggregation device is described below in which the log files for the respective servers are collected into the single log file and compressed.

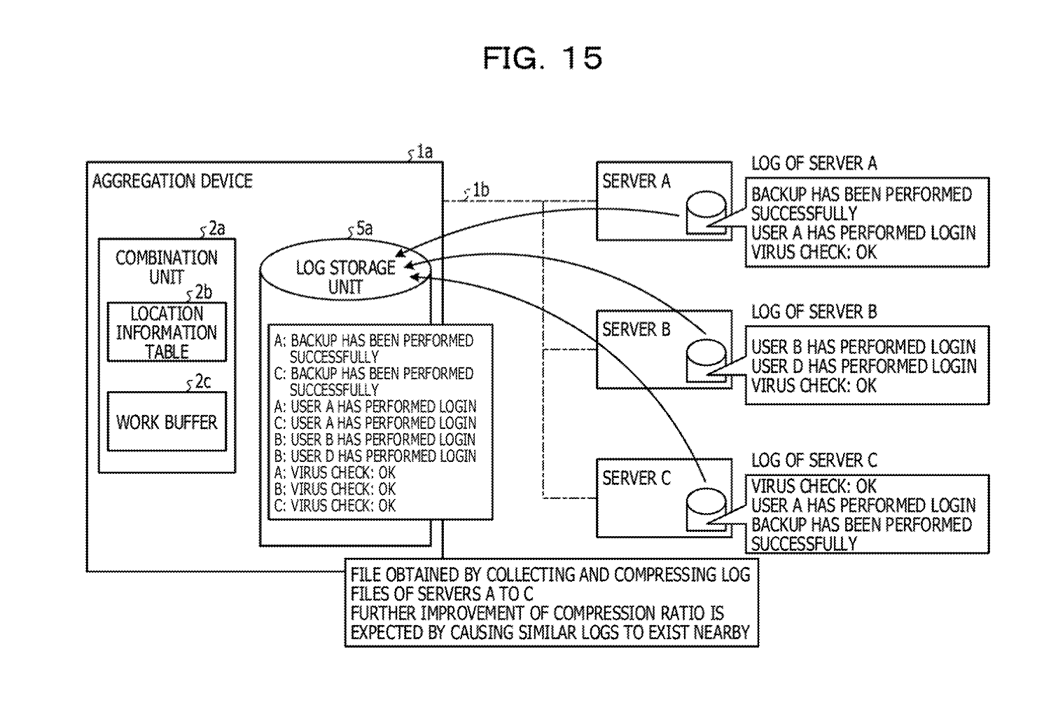

First, combination of log files by the aggregation device according to the second embodiment is described. FIG. 15 is a diagram illustrating the combination of log files by the aggregation device according to the second embodiment. As illustrated in FIG. 15, the aggregation device 1a according to the second embodiment obtains log files from servers A to C through a network 1b. In addition, the aggregation device 1a combines the plurality of log files obtained from the servers A to C to create a single log file, compresses the created log file, and stores the compressed log file in a log storage unit 5a.

The aggregation device 1a includes a combination unit 2a in addition to the function units illustrated in FIG. 12. The combination unit 2a combines the plurality of log files obtained from the servers A to C to create a single log file. The combination unit 2a includes a location information table 2b and a work buffer 2c.

The same logs are included in the logs of the plurality of servers A to C. For example, a log “backup has been performed successfully” of the server A is also included in the server C. A log “virus check: OK” of the server A is also included in the servers B and C. Thus, the aggregation device 1a may further improve the compression ratio by rearranging the logs so that logs including the same character string exist nearby for the log file obtained by combining the plurality of log files.

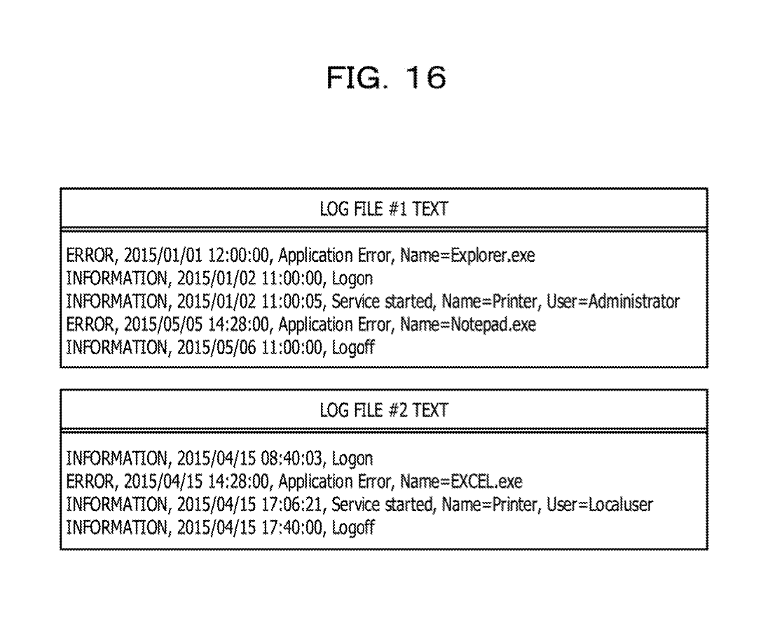

FIGS. 16 to 20 are diagrams each illustrating combination of log files using two log file as an example. FIG. 16 is a diagram illustrating an example of two log files. As illustrated in FIG. 16, five logs are included in a log file #1, and four logs are included in a log file #2.

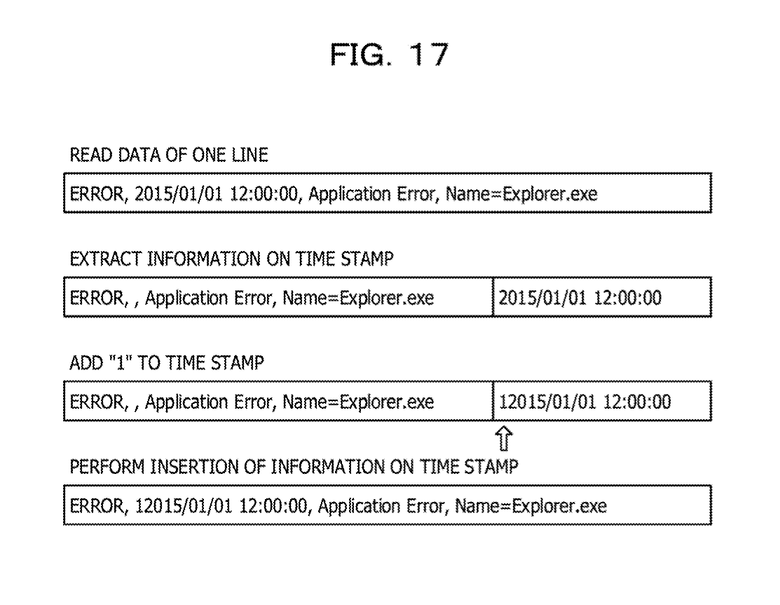

The combination unit 2a adds addition information associated with a log file, to the beginning of a time stamp of each of the logs. FIG. 17 is a diagram illustrating a procedure in which addition information associated with a log file is added to the beginning of a time stamp.

As illustrated in FIG. 17, the combination unit 2a reads data of a single line from the log file #1, and extracts information on a time stamp from the read data using time stamp location information. In addition, the combination unit 2a adds addition information “1” associated with the log file #1, to the beginning of the time stamp. In FIG. 17, “1” is added to the beginning of a time stamp “2015/01/01 12:00:00”, and the time stamp is changed to “12015/01/01 12:00:00”. In addition, the combination unit 2a inserts the information on the time stamp into the original position using the time stamp location information.

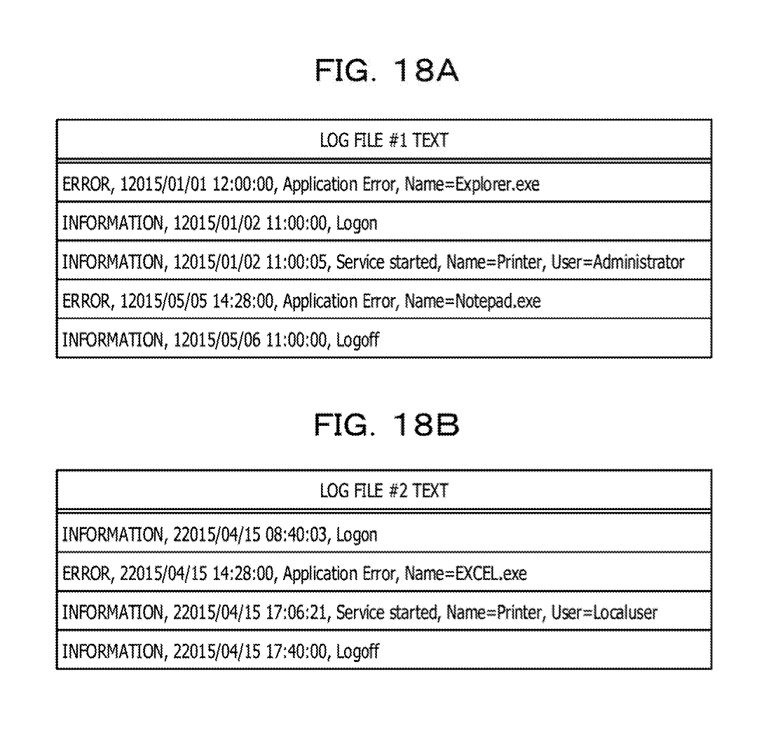

After the combination unit 2a executes the processing illustrated in FIG. 17 for each of the lines of the log file #1, the combination unit 2a executes processing similar to the processing illustrated in FIG. 17 for each of the lines of the log file #2. FIGS. 18A and 18B are diagrams each illustrating the log file after addition information associated with the log file is added to the beginnings of the time stamps. As illustrated in FIGS. 18A and 18B, “1” is added to the beginning of the time stamp of each of the logs of the log file #1, and as illustrated in FIG. 18B, “2” is added to the beginning of the time stamp of each of the logs of the log file #2.

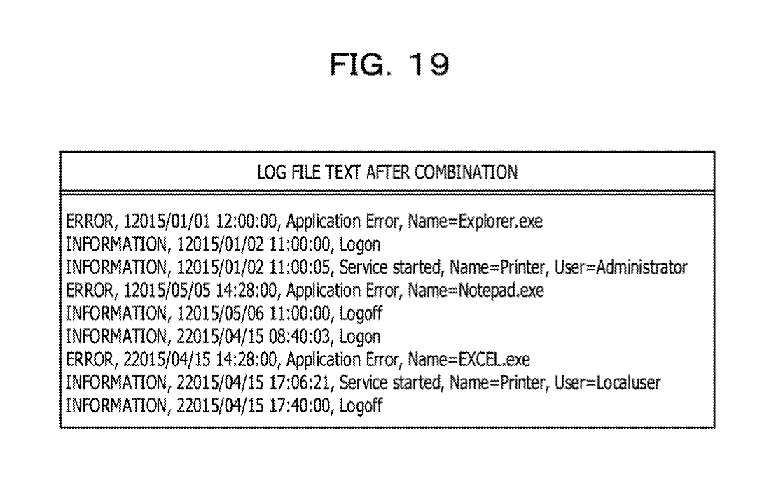

In addition, the combination unit 2a adds the log file #2 to the end of the log file #1 to create a single log file. FIG. 19 is a diagram illustrating the log file after the combination. As illustrated in FIG. 19, the four logs from the first log “Information, 22015/04/15 08:40:03, Logon” of the log file #2 are added to the last log “Information, 12015/05/06 11:00:00, Logoff” of the log file #1.

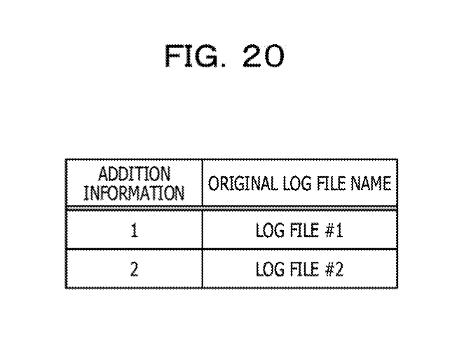

In addition, the combination unit 2a creates and stores a correspondence table in which addition information and an original log file name are associated with each other. FIG. 20 is a diagram illustrating an example of the correspondence table between the addition information and the original log file name. As illustrated in FIG. 20, an original log file name “log file #1” is associated with addition information “1”. An original log file name “log file #2” is associated with addition information “2”.

In addition, the combination unit 2a transmits the log file after the combination to the preprocessing unit 3. In the log file #2, there is only a single log including “Application Error”. In addition, in the log file #1, there are two logs including “Application Error”. Therefore, when the two log files are combined into the single log file and compressed, the file size after the compression may be reduced as compared with the case in which two log files are compressed separately.

The aggregation device 1a divides the restored log file into the two log files based on the beginnings of the time stamps, and removes the addition information from the beginning of the time stamp of each of the logs. Therefore, the aggregation device 1a may restore the original two log files. As described above, the combination unit 2a adds the addition information to the beginning of the time stamp. However, the addition information may be added to another location such as the end of the time stamp or location other than the time stamp.

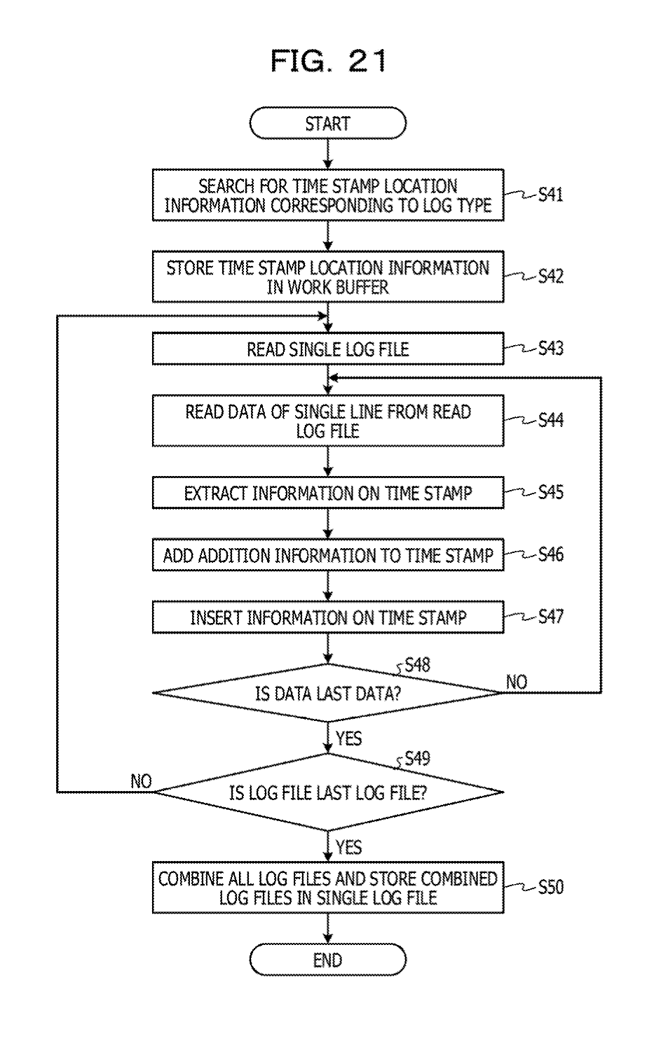

FIG. 21 is a flowchart illustrating a flow of multiple file combination processing. As illustrated in FIG. 21, the combination unit 2a searches the location information table 2b for time stamp location information corresponding to the log type (S41), and stores the time stamp location information in the work buffer 2c (S42).

After that, the combination unit 2a reads a single log file (S43). In addition, the combination unit 2a reads data of a single line in the read log file (S44). In addition, the combination unit 2a extracts information on a time stamp from the read data (S45), and adds addition information to the time stamp (S46).

After that, the combination unit 2a inserts the information on the time stamp to the original position (S47) and determines whether the data is the last data in the log file (S48). In addition, when the data is not the last data in the log file, in the combination unit 2a, the flow returns to S44. In addition, when the data is the last data in the log file, the combination unit 2a determines whether the log file is the last log file (S49).

After that, when the log file is not the last log file, in the combination unit 2a, the flow returns to S43. In addition, when the log file is the last log file, the combination unit 2a combines all of the log files and stores the combined log files as a single log file (S50).

As described above, the combination unit 2a may increase a probability in which there is a plurality of logs including the same character string by collecting the plurality of log files into a single log file to improve the compression ratio.

As described above, in the second embodiment, the combination unit 2a adds addition information associated with the log file name, to the beginning of the time stamp of each of the logs of the plurality of log files, and collects the plurality of log files to create a single log file. Thus, the aggregation device 1a may further improve the compression ratio.

In the first and second embodiments, logs are returned to the original order using pieces of order information. However, logs may be returned to the original order using time stamps instead of the pieces of order information. When the time stamps are used, the pieces of order information become unnecessary, so that the aggregation device may further improve the compression ratio.

However, in practice, order of the time stamps may not be matched with the order in which output of the logs have been performed. For example, in many cases, a time inside an operating system (OS) is synchronized with another server. However, the synchronization timing is periodical, and the shifted time is modified by the synchronization timing. Particularly, when the time is modified to the previous time, the consistency of order of the outputs and order of the times may not be obtained between logs before and after the modified time. Therefore, only when order of time stamps is guaranteed in the actual log file, pieces of time stamp information may be used instead of pieces of order information.

Checking whether the pieces of time stamp information may be used instead of pieces of order information is allowed to be performed by processing in which the preprocessing unit 3 reads data of a single line in a log file. For example, when the preprocessing unit 3 reads the single line and extracts information on a time stamp, the preprocessing unit 3 stores information on the time stamp in a temporary buffer. In addition, when the preprocessing unit 3 has read the next line, the preprocessing unit 3 compares the stored information on the time stamp in the previous line, with information on a time stamp in the next line. In addition, the preprocessing unit 3 determines “true” when the time of the time stamp in the previous line is earlier than that of the next line, and determines “false” in other cases. In addition, the preprocessing unit 3 determines that pieces of time stamp information may be used instead of pieces of order information when the preprocessing unit 3 does not even once determine “false” at a time point at which the processing has been completed for all of the lines.

In the second embodiment, even in the state in which the plurality of log files is combined, when the logs are returned to the original order, sorting is performed by pieces of information on the original log file, which have been added to the beginnings of time stamps first, and then sorting is performed by the time stamps, so that the time stamps are allowed to be used instead of the pieces of order information. However, it is desirable that the consistency of order of the time stamps is guaranteed in all of the combined log files.

In the first and second embodiment, the aggregation device is described above. However, an aggregation program having a function similar to the aggregation device may be obtained when the configuration included in the aggregation device is achieved by software. Here, a computer that executes the aggregation program is described below.

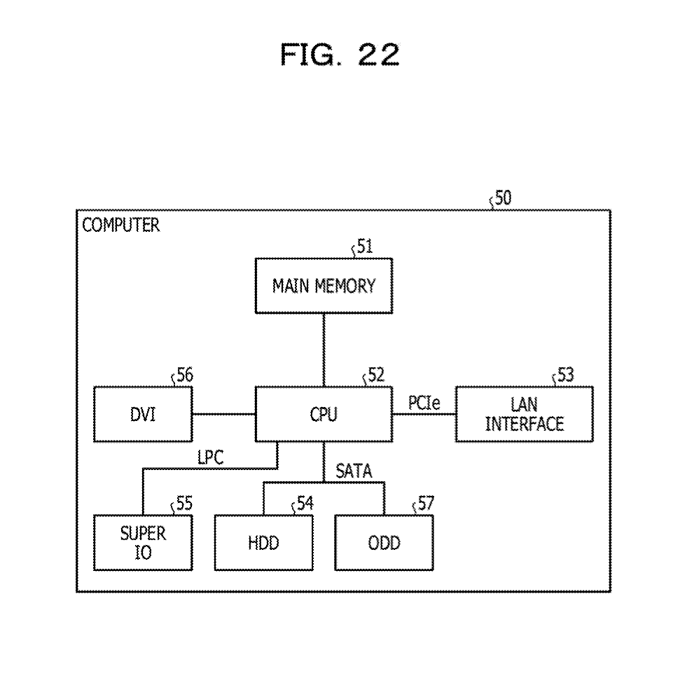

FIG. 22 is a diagram illustrating a hardware configuration of a computer that executes an aggregation program according to an embodiment. As illustrated in FIG. 22, a computer 50 includes a main memory 51, a central processing unit (CPU) 52, a local area network (LAN) interface 53, and a hard disk drive (HDD) 54. The computer 50 includes a super input output (IO) 55, a digital visual interface (DVI) 56, and an optical disk drive (ODD) 57.

The main memory 51 is a memory that stores a program, an execution intermediate result, and the like. The CPU 52 is a central processing device that reads the program from the main memory 51 and executes the program. The CPU 52 includes a chipset including a memory controller.

The LAN interface 53 is an interface used to couple the computer 50 to another computer through a LAN. The HDD 54 is a hard disk device that stores a program and data. The super IO 55 is an interface used to perform connection with input devices such as a mouse and a keyboard. The DVI 56 is an interface used to perform connection with a liquid crystal display device. The ODD 57 is a device that performs reading and writing for a digital versatile disc (DVD).

The LAN interface 53 is coupled to the CPU 52 though PCI express (PCIe). The HDD 54 and the ODD 57 are coupled to the CPU 52 through serial advanced technology attachment (SATA). The super IO 55 is coupled to the CPU 52 through low pin count (LPC).

In addition, the aggregation program that is to be executed in the computer 50 is stored in a DVD, read from the DVD through the ODD 57, and installed to the computer 50. Alternatively, the aggregation program is stored in a database or the like of another computer system coupled to the computer 50 through the LAN interface 53, read from the database or the like, and installed to the computer 50. In addition, the installed aggregation program is stored in the HDD 54, read to the main memory 51, and executed by the CPU 52.

In the embodiments, the case is described above in which the log files of the servers are compressed. However, the embodiments are not limited to such a case, and for example, the embodiments may be applied to a case in which log files of other devices such as switches are compressed, similarly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A log management method executed by a processor included in a log management device that manages logs of a plurality of devices, the log management method comprising:
receiving a plurality of logs from one of the plurality of devices;
generating a plurality of time stamps and a plurality of bodies by separation of the plurality of time stamps from the plurality of logs;
sorting the plurality of time stamps and the plurality of bodies based on information included in the plurality of bodies;
compressing the sorted plurality of bodies and the plurality of sorted time stamps;
restoring, when a request to refer to the plurality of logs is received, the plurality of logs by decompressing the compressed plurality of bodies and the plurality of compressed time stamps; and
outputting the restored plurality of logs.

2. The log management method according to claim 1, wherein
the generating includes generating a plurality of order data indicating time-sequential order information of the plurality of logs,
the compressing includes compressing the plurality of order data, and
the restoring includes restoring the plurality of logs based on the plurality of order data.

3. The log management method according to claim 2, wherein the restoring includes:
rearranging the sorted plurality of bodies and the plurality of sorted time stamps in original order based on the plurality of order data,
restoring the plurality of logs so that the plurality of time stamps are inserted into the plurality of bodies that correspond to the plurality of time stamps and are rearranged in the original order, and
deleting the plurality of order data from the logs.

4. The log management method according to claim 1,
wherein the information included in the plurality of bodies are character information.

5. The log management method according to claim 1, wherein the sorting includes:
sorting the plurality of bodies based on the information included in the plurality of bodies, and
sorting the plurality of time stamps so that the order of the plurality of time stamps is changed in accordance with the order of the sorted plurality of bodies.

6. The log management method according to claim 1, wherein
the plurality of logs is transmitted from each of the plurality of devices,
the generating includes generating a single log file so that the plurality of logs transmitted from each of the plurality of devices is combined, and
the compressing includes compressing the single log file.

7. The log management method according to claim 6,
wherein the generating includes adding information indicating a log type to a beginning of each of the plurality of time stamps included in the single log file.

8. The log management method according to claim 1,
wherein the compressing includes performing compressing so that a target character string included in each of the plurality of bodies or each of the plurality of time stamps is replaced with information indicating a position and a length of a character string that is identical to the target character string included in each of the plurality of bodies or each of the plurality of time stamps.

9. A log management device that manages logs of a plurality of devices, the log management device comprising:
a memory; and
a processor coupled to the memory and configured to,
receive a plurality of logs from one of the plurality of devices,
generate a plurality of time stamps and a plurality of bodies by separation of the plurality of time stamps from the plurality of logs,
sort the plurality of time stamps and the plurality of bodies based on information included in the plurality of bodies,
compress the sorted plurality of bodies and the plurality of sorted time stamps,
restore, when a request to refer to the plurality of logs is received, the plurality of logs by decompressing the compressed plurality of bodies and the plurality of compressed time stamps, and
output the restored plurality of logs.

10. The log management device according to claim 9, wherein the processor is configured to:
generate a plurality of order data indicating time-sequential order information of the plurality of logs,
compressing the plurality of order data, and
restore the plurality of logs based on the plurality of order data.

11. The log management device according to claim 10, wherein the processor is configured to:
rearrange the sorted plurality of bodies and the plurality of sorted time stamps in original order based on the plurality of order data,
restore the plurality of logs so that the plurality of time stamps are inserted into the plurality of bodies that correspond to the plurality of time stamps and are rearranged in the original order, and
delete the plurality of order data from the logs.

12. The log management device according to claim 9,
wherein the information included in the plurality of bodies are character information.

13. The log management device according to claim 9, wherein the processor is configured to:
sort the plurality of bodies based on the information included in the plurality of bodies, and
sort the plurality of time stamps so that the order of the plurality of time stamps is changed in accordance with the order of the sorted plurality of bodies.

14. A non-transitory computer-readable recording medium storing a program that causes a processor included in a log management device that manages logs of a plurality of devices to execute a process, the process comprising:
receiving a plurality of logs from one of the plurality of devices;
generating a plurality of time stamps and a plurality of bodies by separation of the plurality of time stamps from the plurality of logs;
sorting the plurality of time stamps and the plurality of bodies based on information included in the plurality of bodies;
compressing the sorted plurality of bodies and the plurality of sorted time stamps;
restoring, when a request to refer to the plurality of logs is received, the plurality of logs by decompressing the compressed plurality of bodies and the plurality of compressed time stamps; and
outputting the restored plurality of logs.
